(19) United States
(12) Patent Application Publication
(10) Pub. No.: US 2026/0291600 A1
(43) Pub. Date: Sep. 24, 2026

(54) FULL-DUPLEX BEAM-NULLING ISOLATION BEWEEN TRANSMIT AND RECEIVE ARRAYS

(71) Applicant: Viasat, Inc., Carlsbad, CA (US)

(72) Inventor: Steven J. FRANSON, Scottsdale, AZ (US)

(21) Appl. No.: 19/475,709

(22) PCT Filed: Apr. 18, 2024
(86) PCT No.: PCT/US2024/025299

§ 371 Date: Oct. 15, 2025

Related U.S. Application Data
(60) Provisional application No. 63/497,163, filed on Apr. 19, 2023.

(51) Int. Cl. H04B 7/08; H04B 1/525; H04B 7/06; H04L 5/14

(52) U.S. Cl. CPC H04B 7/08; H04B 1/525; H04B 7/06; H04L 5/14

(57) ABSTRACT

Methods, systems, and devices for full-duplex beam-nulling isolation between transmit and receive arrays are described. For example, the described techniques provide for identifying respective signals to be transmitted from a transmit array and to be received at a receive array of a phased array antenna system. The transmit array and the receive array may be located proximate to each other in the phased array antenna system. The system may determine respective beam weights of signals to be transmitted from a transmit array and to be received at a receive array such that the respective beam weights generate a respective null in one or more directions between the transmit array and the receive array. Then the system may transmit signals at the transmit array and receive signals at the receive array in accordance with their respective beam weights.

### CROSS REFERENCE

The present Application is a 371 national phase filing of International Patent Application No. PCT/US2024/025299 by FRANSON entitled, “FULL-DUPLEX BEAM-NULLING ISOLATION BETWEEN TRANSMIT AND RECEIVE ARRAYS”, filed Apr. 18, 2024 and to U.S. Provisional Patent Application No. 63/497,163 by FRANSON, entitled “FULL-DUPLEX BEAM-NULLING ISOLATION BETWEEN TRANSMIT AND RECEIVE ARRAYS”, filed Apr. 19, 2023, each of which is assigned to the assignee hereof and each of which is hereby incorporated by reference in its entirety.

### BACKGROUND

The following relates generally to communications, including full-duplex beam-nulling isolation between transmit and receive arrays.

In satellite communications systems or other communications systems, phased array antennas may be used for particular applications where it is beneficial to electronically steer signal beams in one or more directions without physically moving the antenna. A phased array antenna includes an array of (e.g., regularly spaced) antenna elements. The antenna elements can be controlled independently using circuitry to control the phase or amplitude of the radio waves transmitted and received by each of the multiple radiating antenna elements. When used as a cooperative assembly, the total radiation pattern of the array is defined by the constructive and destructive interference of the individual radiation patterns from each antenna element.

### SUMMARY

The described techniques relate to improved methods, systems, devices, and apparatuses that support full-duplex beam-nulling isolation between transmit and receive arrays. For example, the described techniques provide for identifying respective signals to be transmitted from a transmit array and to be received at a receive array of a phased array antenna system. The transmit array and the receive array may be located proximate to each other in the phased array antenna system. The system may determine respective beam weights of signals to be transmitted from a transmit array and to be received at a receive array such that the respective beam weights generate a respective null in one or more directions between the transmit array and the receive array. Then the system may transmit signals at the transmit array and receive signals at the receive array (e.g., concurrently) in accordance with their respective beam weights.

### BRIEF DESCRIPTION OF THE DRAWINGS

FIG. 1 shows an example of a satellite communication system that supports full-duplex beam-nulling isolation between transmit and receive arrays in accordance with examples described herein.

FIG. 2 shows an example of an antenna assembly 200 that supports full-duplex beam-nulling isolation between transmit and receive arrays in accordance with examples described herein.

FIG. 3 shows an example of a radiation chart 300 that supports full-duplex beam-nulling isolation between transmit and receive arrays in accordance with aspects of the present disclosure.

FIGS. 4A and 4B show examples of beam weight adjustment configurations 400 and 450, respectively, that supports full-duplex beam-nulling isolation between transmit and receive arrays in accordance with aspects of the present disclosure.

FIG. 5 shows an example of a phased array antenna system 500 that supports full-duplex beam-nulling isolation between transmit and receive arrays in accordance with aspects of the present disclosure.

FIG. 6 shows a block diagram 600 of a device 605 that supports full-duplex beam-nulling isolation between transmit and receive arrays in accordance with aspects of the present disclosure.

FIG. 7 shows a diagram of a system 700 including a device 705 that supports full-duplex beam-nulling isolation between transmit and receive arrays in accordance with aspects of the present disclosure.

FIG. 8 illustrates a flowchart illustrating a method 800 that supports full-duplex beam-nulling isolation between transmit and receive arrays in accordance with aspects of the present disclosure.

### DETAILED DESCRIPTION

Phased array antennas, composed of multiple individual antenna elements working together as a single antenna system, have been widely adopted in various wireless communications applications, notably radar systems, satellite communications systems, and various other wireless communications infrastructure. These antennas, due to their ability to steer the direction of signal beams electronically without physically moving the antenna, offer significant benefits in terms of mechanical complexity, physical size, and beam adjustment speed.

Full-duplex communications refers to concurrent bi-directional communications. Full-duplex communications with a single antenna often utilizes a diplexer which separates transmit and receive signals according to frequency, restricting the frequency bands that can be used for transmission and reception. Alternatively, a single antenna may utilize separate polarization multiplexing to transmit and receive signals concurrently, but it may be challenging to eliminate cross-polarization interference for orthogonal polarizations, which may reduce signal quality. To mitigate some of the effects of full-duplex communications using a single antenna, a full-duplex phased array antenna with separate transmit and receive arrays may be used. However, a persistent challenge with phased array systems is self-interference, which occurs when parts of a transmitted signal unintentionally interact with a received signal, resulting in degraded signal performance, a saturated receiver, or even total communication failures.

The self-interference issue arises due to the close proximity and synchronous operation of multiple antennas in the phased array antenna system. When these antenna systems simultaneously transmit and receive signals, it's common for energy of the transmitted signal to be received by the same antenna system, causing interference. This form of interference is especially challenging to deal with as traditional methods of interference mitigation are often insufficient or not applicable. The challenge of dealing with this self-interference is a reason why some wireless systems have traditionally been either half-duplex or used different or widely spaced frequency channels for uplink and downlink. However, although transmitting and receiving signals at the same time (e.g., full-duplex) may result in self-interference issues, full-duplex can be desirable over half-duplex operation as full-duplex operation can double the data throughput of a system.

According to techniques described herein, a phased array antenna system may include both a transmit array and a receive array. The system may identify one or more signals to transmit from the transmit array and one or more signals to receive at the receive array. Both the transmit and receive arrays may be located proximate to each other in the phased array antenna system. For the transmitted and received signals, the system may determine respective beam weights for communication of the signals via the transmit and receive arrays. The beam weights are determined such that a respective null is generated in one or more directions between the transmit array and the receive array. Then the system transmits one or more signals via the transmit array and receives one or more signals via the receive array in accordance with the determined respective beam weights. These techniques mitigate self-interference in phased array antenna systems, which may improve throughput for the received signals for full-duplex communications.

Aspects of the disclosure are initially described in the context of satellite communication systems. Aspects of the disclosure are illustrated by and described with reference to apparatus diagrams, system diagrams, block diagrams, and flowcharts that relate to full-duplex beam-nulling isolation between transmit and receive arrays.

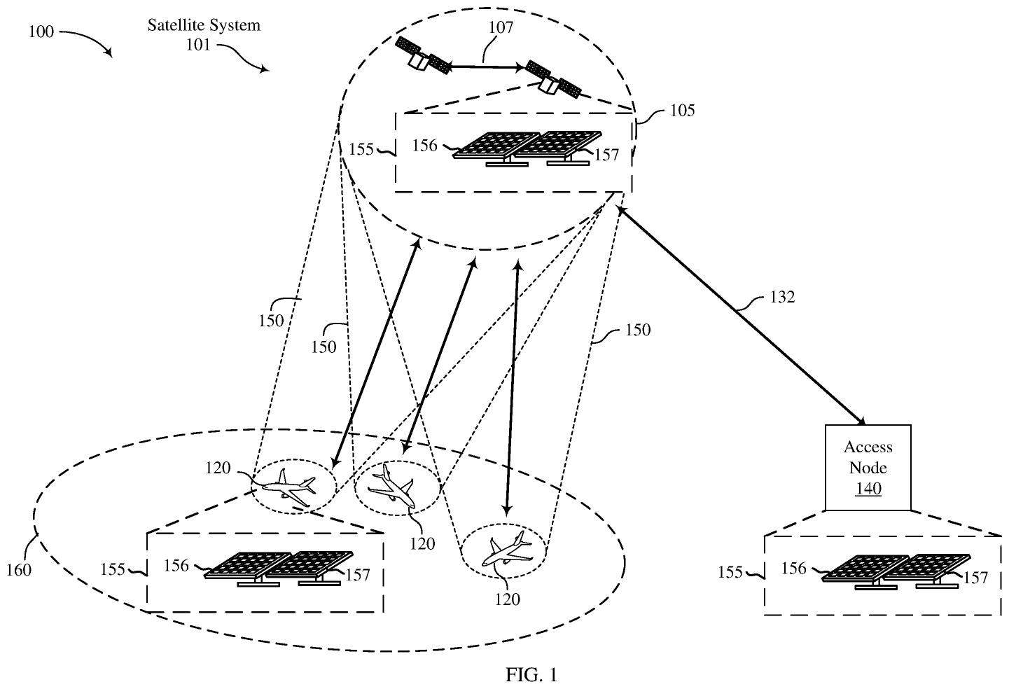

FIG. 1 shows an example of a satellite communication system 100 that supports full-duplex beam-nulling isolation between transmit and receive arrays in accordance with examples described herein. Satellite communication system 100 may include a ground system a network of access nodes 140, terminals 120, and satellite system 101. The network of access nodes 140 may be configured to communicate with the satellite system 101 via a feeder link 132.

Terminals 120 may include various devices configured to communicate signals with the satellite system 101. Although terminals 120 are illustrated as being on aircraft, terminals 120 may include fixed terminals (e.g., ground-based stationary terminals), or mobile terminals mounted on mobile platforms (e.g., boats, aircraft, ground-based vehicles, and the like), or a combination of fixed and mobile terminals. A terminal 120 may communicate data and information with an access node 140 via the satellite system 101.

Terminals 120 may include an antenna assembly which may also include various hardware for mounting an antenna. An antenna assembly may also include circuits and/or processors for converting (e.g., performing frequency conversion, modulating/demodulating, multiplexing/demultiplexing, filtering, forwarding, etc.) between radio frequency (RF) satellite communication signals, and satellite terminal communications signals transmitted between the antenna and a satellite terminal receiver. For mobile terminals, the antenna assembly may be mounted on the outside of the mobile platform (e.g., outside of the fuselage of an aircraft). Additionally, or alternatively, the terminal 120 may include a transceiver, which may be mounted on the inside or outside of the mobile platform and may include circuits and/or processors for performing various RF signal operations (e.g., receiving, performing frequency conversion, modulating/demodulating, multiplexing/demultiplexing, etc.).

The satellite system 101 may include a single satellite 105, or a network of satellites 105 that are deployed in space orbits (e.g., low earth orbits, medium earth orbits, geosynchronous orbits, geostationary orbits, etc.). One or more satellites 105 included in satellite system 101 may be equipped with multiple antennas (e.g., one or more antenna arrays). In some examples, the one or more satellites 105 equipped with multiple antennas may each include one or more antenna panels that include an array of (e.g., evenly distributed) antennas (which may also be referred to as antenna elements).

The satellite system 101 may use the one or more satellites to support beamforming techniques within the coverage area 160 of the satellite system to increase a utilization of resources used for communications. Beamforming, including using multiple-input multiple-output (MIMO) techniques, may be used to exploit multipath signal propagation and increase spectral efficiency by transmitting or receiving multiple signals via different spatial layers over the same frequency resources. The multiple signals may, for example, be transmitted by a transmitting device (e.g., a satellite system) via a set of antennas in accordance with a set of weighting coefficients or beam weights. Likewise, the multiple signals may be received by a receiving device (e.g., a satellite system) via a set of antennas in accordance with a set of beam weights. Each of the multiple signals may be associated with a separate spatial stream and may carry bits associated with the same data stream (e.g., the same codeword) or different data streams (e.g., different codewords).

In some examples, some or all of the antenna elements on the satellite and/or the ground system may be arranged as an array of constituent receive and/or transmit antenna elements that cooperate to enable various examples of on-board beamforming (OBBF), ground-based beamforming (GBBF), end-to-end beamforming, or other types of beamforming. In the GBBF implementation, there may be multiple transmit or receive antennas on the ground system access node(s).

To determine beam weights to apply to the set of antennas such that N spatial layers are formed, an (M×N) MIMO matrix may be formed, where M may represent the quantity of antennas of the set of antennas. In some examples, M may be equal to N. The MIMO matrix may be determined based on a channel matrix and used to isolate the different spatial layers of the channel. In some examples, the beam weights are selected to emphasize signals transmitted using the different spatial layers while reducing interference of signals transmitted in the other spatial layers. Accordingly, processing signals received at each antenna of the set of antennas (e.g., a signal received at the set of antennas) using the MIMO matrix may result in multiple signals being output, where each of the multiple signals may correspond to one of the spatial layers.

In some examples, the beam weights used for MIMO communications may be referred to as beam coefficients or beamforming coefficients, and the multiple spatial layers may be referred to as beams 150 or spot beams 150.

Beamforming is a signal processing technique that may be used to shape or steer an antenna beam (e.g., a transmit beam, a receive beam) along a spatial path. A communication beam may be formed by determining beam weights for antenna elements of an antenna array that result in the signals transmitted from or received at the antenna elements being combined such that signals propagating in a particular orientation with respect to an antenna array experience constructive interference while others experience destructive interference. Thus, beamforming may be used to transmit signals having energy that is focused in a direction of a communication beam and to receive signals that arrive in a direction of the communication with increased signal power (relative to the absence of beamforming). The adjustments associated with each of the antenna elements may be defined by a beamforming weight set associated with a particular orientation (e.g., with respect to the antenna array of the transmitting device or receiving device, or with respect to some other orientation). The beam weights may be used to apply amplitude offsets, phase offsets, or both to signals carried via the antennas.

In some examples, the beam weights applied to the antennas may be used to form multiple beams, each associated with a different direction, where the multiple beams may be used to communicate multiple signals having the same frequency at the same time to different user terminals. This may be referred to as Multiuser MIMO. The beam weights used for beamforming may be referred to as beam coefficients, and the multiple signals may be referred to as beam signals. The resulting beams may be referred to herein as beamformed spot beams 150, spot beams 150, or beams 150.

The amplitude and phase of each beam weights may be calculated given the antenna array (and reflector geometry, if present) and location and the desired beam locations. Various beamformer calculation and adaptation techniques may be used, including minimum mean square (MMSE) beamformer, zero forcing beamformer, MIMO sphere decoder, and others.

In some examples, terminals 120 may include a phased array antenna system 155, which may be configured for bi-directional communications with the satellite 105 via a spot beam 150. A phased array antenna system 155 may include an array (e.g., a two-dimensional array) of transmit antenna elements 156 and receive antenna elements 157 that are physically arranged in a respective transmit and receive array assemblies, and signals of respective transmit antenna elements 156 and receive antenna elements 157 may be manipulated according to various beamforming techniques (e.g., phase and/or amplitude manipulation) to support terminal spot beams (not shown), such as transmit beams (e.g., directional transmission) and receive beams (e.g., directional reception). In other words, communication via a phased array antenna system 155 may be electronically configurable using the array of transmit antenna elements 156 and receive antenna elements 157 to align signal transmission and/or reception along a desired direction (e.g., a terminal spot beam orientation).

Additionally or alternatively, satellite 105 or access node 140 may include a phased array antenna system 155. Satellites 105 within satellite system 101 may communicate with terminals 120 via a beam 150 or with each other via space link 107. For example, satellite 105 may using beamforming to communicate with other satellites using the transmit antenna elements 156 and receive antenna elements 157.

A receive antenna element 157 may include a physical transducer (e.g., an RF transducer) that converts an electromagnetic signal to an electrical signal, and a transmit antenna element 156 may include a physical transducer that emits an electromagnetic signal when excited by an electrical signal. The same physical transducer may be used for transmitting and receiving, in some cases. Each of the antenna elements may include, for example, a feed horn, a polarization transducer (e.g., a septum polarized horn, which may function as two combined elements with different polarizations), a multi-port multi-band horn (e.g., dual-band 20 GHz/ 30 GHz with dual polarization LHCP/RHCP), a cavity-backed slot, an inverted-F, a slotted waveguide, a Vivaldi, a Helical, a loop, a patch, or any other configuration of an antenna element or combination of interconnected sub-elements. Each of the antenna elements may also include, or be otherwise coupled with an RF signal transducer, a low noise amplifier (LNA), or high power amplifier (HPA), and may be coupled with transponders for performing other signal processing such as frequency conversion, beamforming processing, and the like.

In some examples, a phased array antenna system 155 may be associated with characteristics (e.g., communication characteristics, signaling characteristics) that are directional in nature, such as gain characteristics, noise characteristics, beamwidth characteristics, or other characteristics that vary depending on a direction of beamforming. In accordance with examples as disclosed herein, a phased array antenna system 155 may identify one or more signals to transmit from a transmit array and one or more signals to receive at a receive array, where both the transmit and receive arrays are located proximate to each other in the phased array antenna. For the transmitted and received signals, the system may then determine respective beam weights for the signals. The beam weights are determined such that a respective null is generated in one or more directions between the transmit array and the receive array. Then the system transmits one or more signals from the transmit array and receives one or more signals from the receive array in accordance with the determined respective beam weights.

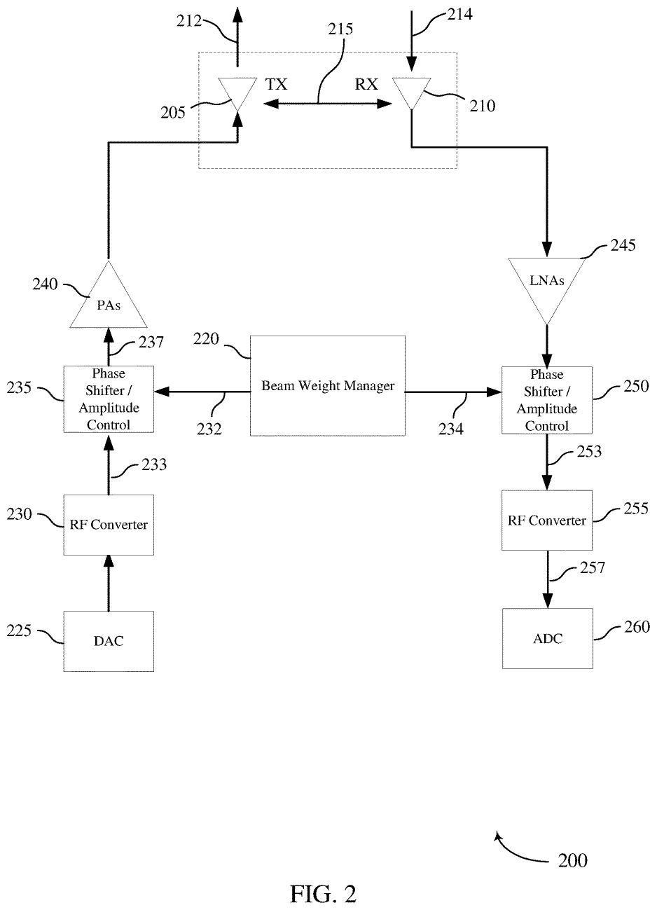

FIG. 2 shows an example of an antenna assembly 200 that supports full-duplex beam-nulling isolation between transmit and receive arrays in accordance with aspects of the present disclosure. Antenna assembly 200 may illustrate portions of a phased array antenna system 155 as described herein. Antenna assembly 200 may comprise various components including transmit array 205, receive array 210, beam weight manager 220, digital-to-analog converter (DAC) 225, radio frequency (RF) converter 230, phase shifter/amplitude control module 235, power amplifiers (PAS) 240, low noise amplifiers (LNAs) 245, phase shifter/amplitude control module 250, RF converter 255, and analog-to-digital converter (ADC) 260.

Transmit array 205 may include one or more transmit antenna elements and receive array 210 may include one or more receive antenna elements. Transmit array 205 and receive array 210 may be located proximate to each other such that energy leakage 215 from the transmit array 205 may cause interference at receive array 210. The distance between transmit array 205 and receive array 210 may be any length that may be practical for utilization in a phased array antenna system. Transmit array 205 and receive array 210 may be coplanar with each other.

Beam weight manager 220 may be used to shape or steer antenna beams associated with transmit array 205 and receive array 210 via the use of beam weights applied to their respective antenna elements. The beam weights may be used to apply amplitude offsets, phase offsets, or both to signals carried via the arrays. The beam weights applied to the antenna elements of the arrays may be used to form multiple beams, each associated with a different direction. The beam weights may be determined based on a type of receive array 210, a type of transmit array 205, a distance between receive array 210 and transmit array 205, or a combination thereof.

In some examples, beam weight manager 220 may determine beam weights for a signal beam for transmission via transmit array 205 in a particular direction, and beam weight manager 220 may determine beam weights to receive a signal via receive array 210 in another direction. In some examples, the target direction of the beam associated with receive array 210 may be oriented towards a same target as the beam associated with transmit array 205, while in other examples the targets for the transmit array 205 and receive array 210 may be different. Beam weight manager 220 may determine transmit beam weights 232 for transmit array 205 and receive beam weights 234 for receive array 210 in order to generate a transmit beam or a receive beam having a null in one or more directions between the two arrays. Once the respective beam weights are determined, phase shifter/amplitude control module 235 may apply the transmit beam weights 232 to a converted RF transmit signal 233 to generate transmit element signals 237 for output by PAs 240 to transmit array 205. Transmit array 205 may transmit a first signal 212 and receive array 210 may receive a second signal 214 in accordance with the applied receive beam weights 234 (e.g., which may be applied in phase shifter/amplitude control module 250). In some examples, the transmitting of the first signal and the receiving of the second signal may occur fully or partially concurrently with each other.

Antenna assembly 200 may determine to transmit one or more bits of information and in some examples may pass the information through RF converter 230 which may upconvert baseband (low-frequency) signals to high-frequency RF signals for over-the-air transmission. PAs 240 may take the signal and significantly boost its amplitude, resulting in a higher power output before the first signal 212 is transmitted via transmit array 205. Although illustrated as a single conversion from the information bits to the carrier frequency (e.g., RF frequency) using DAC 225 and RF converter 230, in some cases the first signal 212 may be upconverted one or more times (e.g., from symbols to an intermediate frequency, from an intermediate frequency to an RF frequency), or alternatively, direct conversion may be employed where the DAC directly creates the RF frequency without the use of an RF converter. Additionally, although phase shifter/amplitude control module 235 is illustrated as being in the analog domain after to DAC 225, phase shifter/amplitude control module 235 may be applied before DAC 225 in the digital domain, in some cases.

LNA 245 may receive a signal from receive array 210 and amplify the received signal (e.g., receive element signals). Phase shifter/amplitude control module250 may apply the receive beam weights 234 to obtain a receive beam signal 253. RF converter 255 may downconvert a high-frequency RF signal to a low-frequency baseband signal that can be demodulated and processed. ADC 260 may filter and convert the baseband signal 257 to a digital signal (e.g., digitized element signals). The digital signal may have symbol information extracted from the receive beam signal (e.g., demodulation). Then the symbol information may then be further processed to obtain information in the received signal (e.g., decoding, packet sequencing). As described above regarding phase shifter/amplitude control module 235, although phase shifter/amplitude control module 250 is illustrated as being in the analog domain before ADC 260, phase shifter/amplitude control module 250 may be applied after ADC 260 in the digital domain, in some cases.

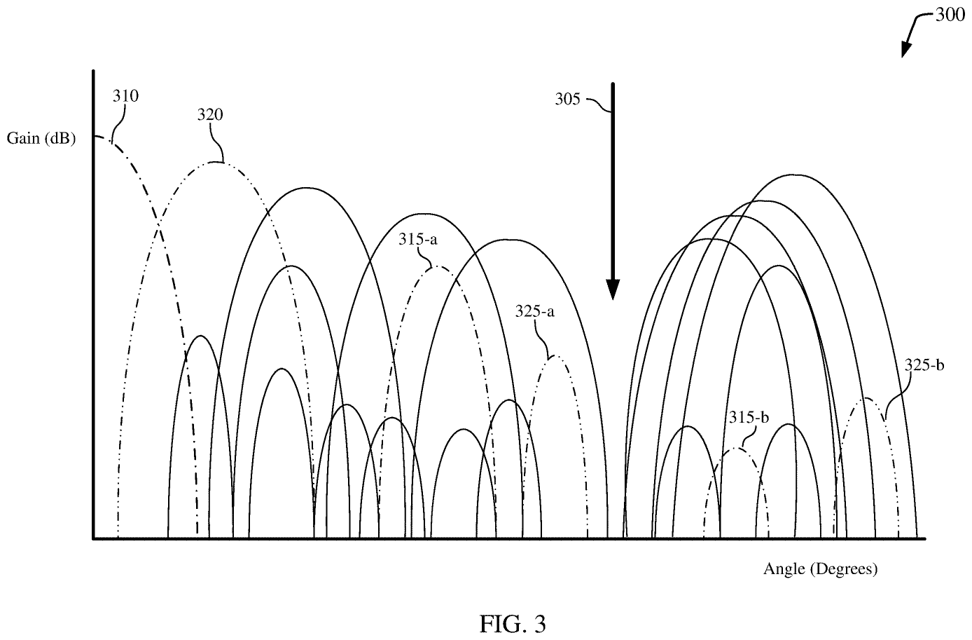

FIG. 3 shows an example of a radiation chart 300 that supports full-duplex beam-nulling isolation between transmit and receive arrays in accordance with aspects of the present disclosure. Radiation chart 300 may illustrate the gain of an antenna in a given direction. In some examples, radiation chart 300 may be the result of scanning an antenna such as a phased array antenna system 155 in one dimension.

Radiation chart 300 may illustrate amounts of radiation that occur as a phased array antenna is steered at different scan angles (e.g., 0 deg, 10 deg, 15 deg., . . . , 60 deg.). At a particular angle, there may be a primary lobe (tallest peak at the particular angle) and its associated side lobes may be distributed throughout radiation chart 300. For example, radiation chart 300 may illustrate a first primary lobe 310 (e.g., associated with a 0 deg. scan angle) with associated sidelobes 315-a and 315-b, and a second primary lobe 320 (e.g., associated with a scan angle of 10 deg.) with associated sidelobes 325-a and 325-b. At angle 305, there is a null that is created such that there is no (or marginal amounts of) energy radiated at the specific scanning angle. Here the beamforming is performed such that any resulting sidelobes from the signal are also not present at angle 305 regardless of the scan angle. Radiation chart 300 may illustrate various lobes for a transmit pattern or a receive pattern.

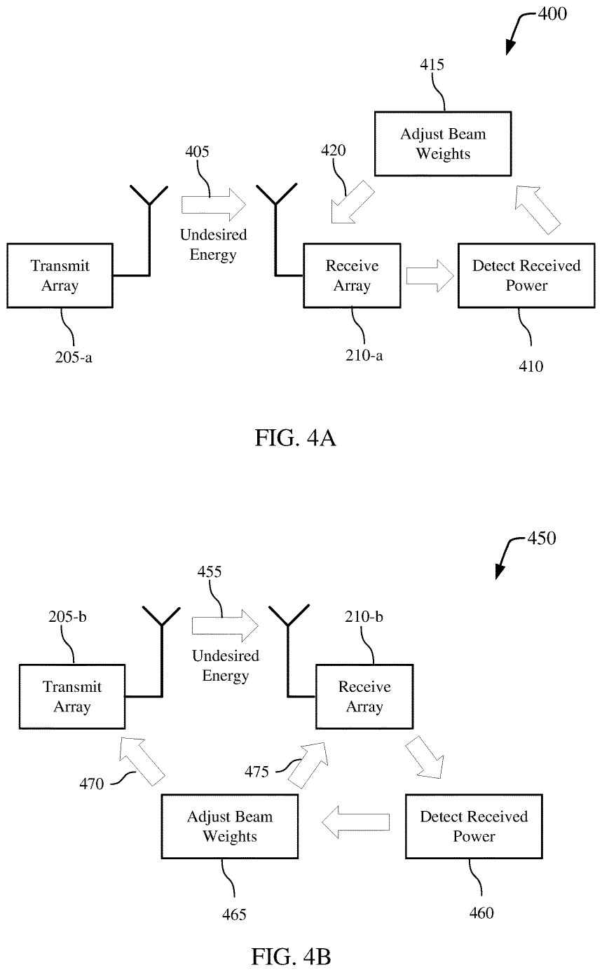

Radiation chart 300 may illustrate calculated beam energy patterns for respective predetermined beam weights that result in a null when a particular scan angle is desired. For example, beam weight manager 220 may calculate beam energy patterns for transmit array 205 to have a null at angle 305 between transmit array 205 and receive array 210. Additionally or alternatively, beam weight manager 220 may calculate beam energy patterns for receive array 210 to have a null at angle 305 between receive array 210 and transmit array 205. However, self-interference between nearby antennas may be difficult to calculate because it may be as a result of near-field effects and thus may be subject to small variations in antenna systems or environment. In this case, feedback adjustment of beam weights within a receive array, or a transmit array and a receive array as described in FIGS. 4A and 4B may be beneficial.

FIGS. 4A and 4B show examples of beam weight adjustment configurations 400 and 450, respectively, that support full-duplex beam-nulling isolation between transmit and receive arrays in accordance with aspects of the present disclosure. Beam weight adjustment configurations 400 and 450 may illustrate techniques in adjusting beam weights at one or more of a transmit array 205 or a receive array 210 of a phased array antenna system in order to generate a null beam in one or more directions.

In beam weight adjustment configuration 400, the transmit array 205-a may transmit a signal towards a target direction using beamforming. However, the beam directed towards the target direction may have radiated energy such as sidelobes which may direct interfering signals or otherwise undesired energy 405 towards the receive array 210-a. At 410, the receive array 210-a may detect one or more signals, including undesired energy 405 (e.g., a component of the first signal transmitted by the transmit array 205-a). The receive array 210-a may detect the one or more signals when the transmit array 205-a is transmitting a signal and there is not a signal from a target being received via the receive array 210-a (e.g., in resources for which the signal from the target to the receive array 210-a transmits zero power). In trying to detect a signal from its intended target in accordance with its applied beam weights, the receive array 210-a may instead receive portions of the undesired energy 405. In detecting the one or more signals, a power level of the component of the first signal may be calculated. The power level may then be compared to a power threshold in order to determine if the interference from the component of the first signal exceeds a threshold associated with an acceptable interference level. If the threshold is exceeded, at 415, the beam weights of one or more antenna elements of the receive array 210-a may be adjusted at 420 in order to create a null in one or more directions of undesired energy 405.

In some examples, in detecting the one or more signals, a signal-to-noise ratio (SNR) of the one or more signals may be calculated. The SNR may then be compared to a SNR threshold in order to determine if the one or more signals exceed a threshold associated with an acceptable interference level. If the threshold is exceeded, at 415, the beam weights of one or more antenna elements of the receive array 210-a may be adjusted in order to create a null in one or more directions of undesired energy 405.

In beam weight adjustment configuration 450, the transmit array 205-b may transmit a signal towards a target direction using beamforming. However, the beam directed towards the target direction may have radiated energy such as sidelobes which may direct interfering signals or otherwise undesired energy 455 towards the receive array 210-b. At 460, the receive array 210-b may detect one or more signals, including undesired energy 455 (e.g., a component of the first signal transmitted by the transmit array 205-b). The receive array 210-b may detect the signals when the transmit array 205-b is transmitting a signal and there is not a signal from a target being received via the receive array 210-b (e.g., in resources for which the signal from the target to the receive array 210-b transmits zero power). In trying to detect a signal from its intended target in accordance with its applied beam weights, the receive array 210-b may instead receive portions of the undesired energy 455. In detecting the one or more signals, a power level of a component of the one or more signals may be calculated. The power level may then be compared to a power threshold in order to determine if the one or more signals exceed a threshold associated with an acceptable interference level. If the threshold is exceeded, at 465, the beam weights of one or more antenna elements of the receive array 210-b may be adjusted at 475 in order to create a null in one or more directions of undesired energy 455. Additionally, the beam weights of one or more antenna elements of the transmit array 205-b may be adjusted at 470 in order to create a null in one or more directions towards the receive array 210-b.

In some examples, in detecting the one or more signals, a SNR of the one or more signals may be calculated. The SNR may then be compared to a SNR threshold in order to determine if the one or more signals exceed a threshold associated with an acceptable interference level. If the threshold is exceeded, at 465, the beam weights of one or more antenna elements of the receive array 210-b may be adjusted in order to create a null in one or more directions of undesired energy 455. Additionally, the beam weights of one or more antenna elements of the transmit array 205-b may be adjusted in order to create a null in one or more directions towards the receive array 210-b.

In adjusting the beam weights of the transmit array 205-b and the receive array 210-b, the adjusting may be based on a beam nulling function, a scan angle, an algorithmic search pattern, an artificial intelligence function, or a combination thereof.

In some examples, beam weight manager 220 may store and later reuse beam weights. For example, initial beam weights for transmit array 205 and receive array 210 may be calculated for various scan angles. In utilizing beam weight adjustment configuration 400 or 450, beam weights for transmit array 205 and receive array 210 may be adjusted for a given scan angle. The respective adjusted beam weights may then be stored and then reused when the given scan angle is utilized again by phased array antenna system 155.

For a two-dimensional scan, respective beam weights for transmit array 205 and receive array 210 may be stored based on a grid. For a given scan angle, the stored beam weights may be interpolated for points between the grid. Accordingly, self-interference at the antenna arrays may be measured at that angle to determine if further adjustment of the beam weights is needed, and if so, a new data point may be created and saved with the adjusted beam weights.

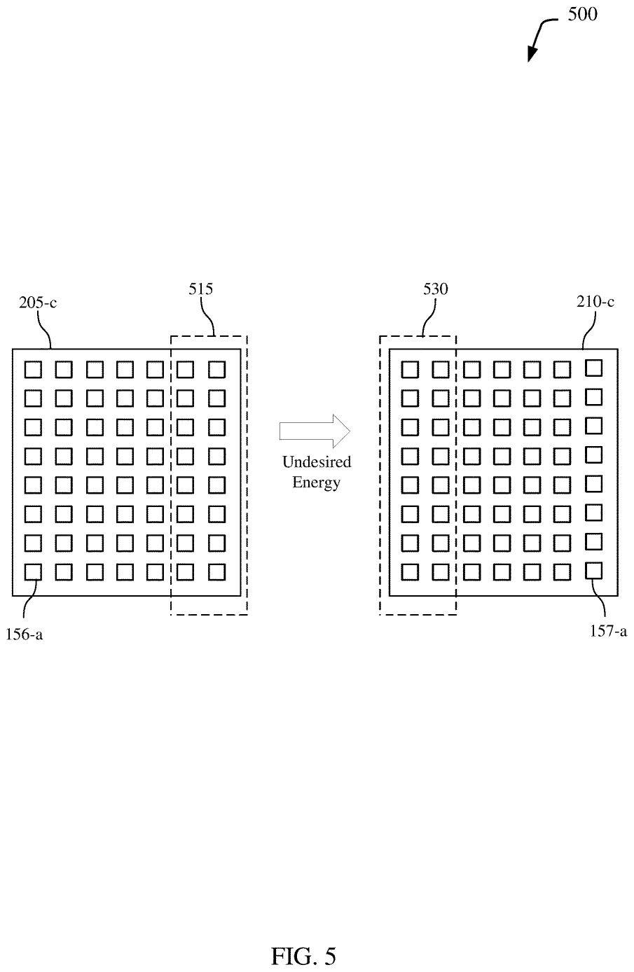

FIG. 5 shows an example of a phased array antenna diagram 500 that supports full-duplex beam-nulling isolation between transmit and receive arrays in accordance with aspects of the present disclosure. Phased array antenna diagram 500 may illustrate portions of a phased array antenna system 155 as described herein.

Phased array antenna diagram 500 may include a transmit array 205-c and a receive array 210-c.

Transmit array 205-c may include one or more transmit antenna elements 156-a. Transmit array 205-c may also comprise edge transmit antenna elements 515. Edge transmit antenna elements 515 may include one or more groups of transmit antenna elements 156-a (e.g., one or more rows) that are located closest to receive array 210-c.

Receive array 210-c may include one or more receive antenna elements 157-a. Receive array 210-c may also comprise edge receive antenna elements 530. Edge receive antenna elements 530 may include one or more groups of receive antenna elements 157-a (e.g., one or more rows) that are located closest to transmit array 205-c.

In an example, transmit array 205-c may transmit a signal towards a target direction using beamforming. However, with the energy directed towards the target direction may have radiated energy such as sidelobes which may direct undesired energy (e.g., a component of the signal transmitted by the transmit array 205-c) towards receive array 210-c. Upon detecting the undesired energy at receive array 210-c, phased array antenna system 155 may adjust the respective beam weights at receive array 210-c and/or transmit array 205-c. In adjusting the respective beam weights, phased array antenna system 155 may adjust one or more antenna elements of edge receive antenna elements 530 and/or edge transmit antenna elements 515.

In some examples, different antenna elements of both transmit array 205-c and receive array 210-c may have different respective beam weights applied to one another. For example, a phased array antenna system 155 may determine an initial set of beam weights for transmit antenna elements 156-a of transmit array 205-c that directs a transmit beam towards a target. During a feedback adjustment process such as beam weight adjustment configuration 450, one or more transmit antenna elements 156-a of edge transmit antenna elements 515 may be adjusted in order to generate a null in one or more directions between transmit array 205-c and receive array 210-c. One or more of the remaining transmit antenna elements 156-a that are not being utilized to generate a null beam may then have beam weights that are applied to orient a primary lobe of a transmit beam in a desired target direction. In another example, the beam weights of one or more transmit antenna elements 156-a of edge transmit antenna elements 515 may be initially set separately such that a null is directed in the direction towards receive array 210-c. For example, the beam weights for the remaining transmit antenna elements 156-a may direct the beam towards the target while the beam weights for the edge transmit antenna elements 515 may be set to cancel energy of the beam generated by the remaining transmit antenna elements 156-a in the direction towards receive array 210-c. This set of beam weights may provide a null for one or more beam weight configuration that phased array antenna system 155 may utilize.

In another example, a phased array antenna system 155 may determine an initial set of beam weights for receive antenna elements 157-a of receive array 210-c that directs a receive beam towards a target. During a feedback adjustment process such as beam weight adjustment configuration 400 or 450, one or more receive antenna elements 157-a of edge receive antenna elements 530 may be adjusted in order to generate a null in one or more directions between transmit array 205-c and receive array 210-c. One or more of the remaining receive antenna elements 157-a that are not being utilized to generate a null beam may then have beam weights that are applied to orient a primary lobe of a receive beam in a desired target direction. In another example, the beam weights of one or more receive antenna elements 157-a of edge receive antenna elements 530 may be initially set separately such that a null is directed in the direction towards transmit array 205-c. For example, the beam weights for the remaining receive antenna elements 157-a may direct the beam towards the target while the beam weights for the edge receive antenna elements 530 may be set to cancel energy of the beam generated by the remaining receive antenna elements 157-a in the direction towards transmit array 205-c. This set of beam weights may provide a null for one or more beam weight configuration that phased array antenna system 155 may utilize.

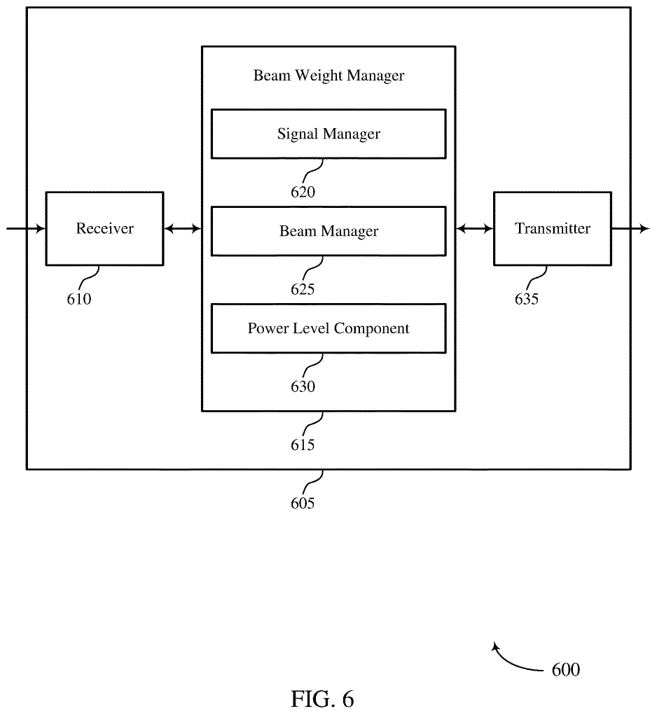

FIG. 6 shows a block diagram 600 of a device 605 that supports full-duplex beam-nulling isolation between transmit and receive arrays in accordance with aspects of the present disclosure. The device 605 may be an example of phased array antenna system 155 as described herein. The device 605 may include a receiver 610, a transmitter 635, and a beam weight manager 615. The device 605, or one or more components of the device 605 (e.g., the receiver 610, the transmitter 635, and the beam weight manager 615), may include at least one processor, which may be coupled with at least one memory, to support the described techniques. Each of these components may be in communication with one another (e.g., via one or more buses).

The receiver 610 may support obtaining information by receiving signals via one or more antennas. The transmitter 635 may support outputting information by transmitting signals via one or more antennas. In some examples, the transmitter 635 and the receiver 610 may be co-located in a transceiver.

The device 605, or various components thereof, may be an example of means for performing various aspects of full-duplex beam-nulling isolation between transmit and receive arrays as described herein. For example, the beam weight manager 615 may include a signal manager 620, a beam manager 625, a power level component 630, or any combination thereof. In some examples, the beam weight manager 615, or various components thereof, may be configured to perform various operations using or otherwise in cooperation with the receiver 610, the transmitter 635, or both. For example, the beam weight manager 615 may receive information from the receiver 610, send information to the receiver 610 or the transmitter 635, or be integrated in combination with the receiver 610, the transmitter 635, or both to obtain information, output information, or perform various other operations as described herein.

The signal manager 620 is capable of, configured to, or operable to support a means for identifying a first signal for transmission via a transmit array of the phased array antenna system and a second signal for reception via a receive array of the phased array antenna system, transmitting the first signal via the transmit array according to the first beam weights, and receiving, at least partially concurrently with transmitting the first signal, the second signal via the receive array according to the second beam weights.

The beam manager 625 is capable of, configured to, or operable to support a means for determining first beam weights for transmission of the first signal towards a first target direction via the transmit array and second beam weights for reception of the second signal from a second target direction via the receive array, adjusting one or more phase components or amplitude components of the one or more of the first beam weights or the second beam weights, determining a first subset of the first beam weights for a first subset of transmit antenna elements of the transmit array and a second subset of the first beam weights for a second subset of transmit antenna elements of the transmit array, combining the first subset of the first beam weights with the second subset of the first beam weights, determining a first subset of the second beam weights for a first subset of receive antenna elements of the receive array and a second subset of the second beam weights for a second subset of receive antenna elements of the receive array, and combining the first subset of the second beam weights with the second subset of the second beam weights.

The power level component 630 is capable of, configured to, or operable to support a means for calculating a power level of a component of the first signal received at the receive array, comparing the power level of the received component of the first signal to a power threshold, adjusting one or more of the first beam weights or the second beam weights based at least in part on determining that the power level of the received component of the first signal exceeds the power threshold, calculating a signal to noise ratio of the first signal received at the receive array, comparing the signal to noise ratio of the first signal to a threshold, and adjusting one or more of the first beam weights or the second beam weights based at least in part on the comparison.

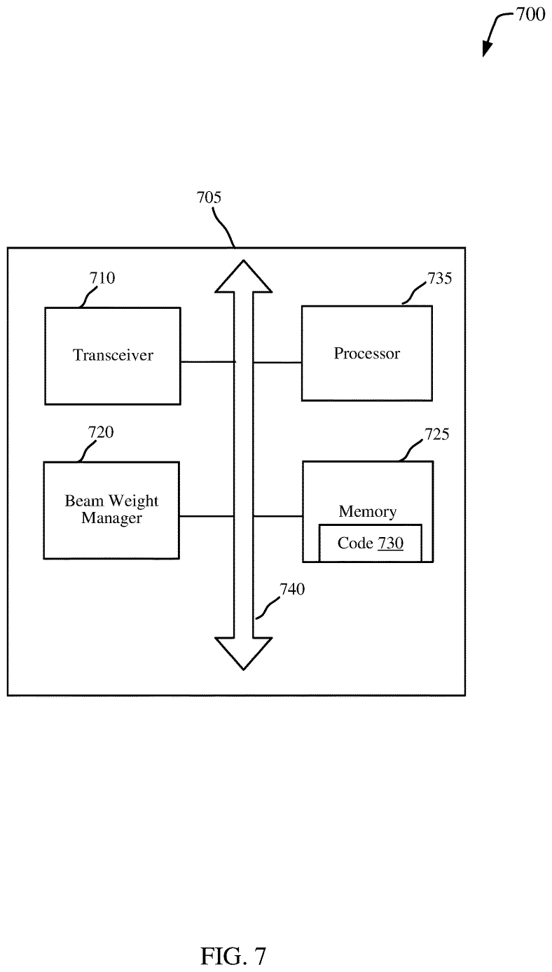

FIG. 7 shows a diagram of a system 700 including a device 705 that supports full-duplex beam-nulling isolation between transmit and receive arrays in accordance with one or more aspects of the present disclosure. The device 705 may be an example of or include the components of a device 605, or a phased array antenna system 155 as described herein. The device 705 may include components that support outputting and obtaining communications, such as a beam weight manager 720, a transceiver 710, at least one memory 725, code 730, and at least one processor 735. These components may be in electronic communication or otherwise coupled (e.g., operatively, communicatively, functionally, electronically, electrically) via one or more buses (e.g., a bus 740).

The at least one memory 725 may include RAM, ROM, or any combination thereof. The at least one memory 725 may store computer-readable, computer-executable code 730 including instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may contain, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting out of band blocker handling for local area base station). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725). In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. As such, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the beam weight manager 720, the at least one memory 725, the code 730, and the at least one processor 735 may be located in one of the different components or divided between different components).

By including or configuring the beam weight manager 720 in accordance with examples as described herein, the device 705 may support techniques for full-duplex beam-nulling isolation between transmit and receive arrays.

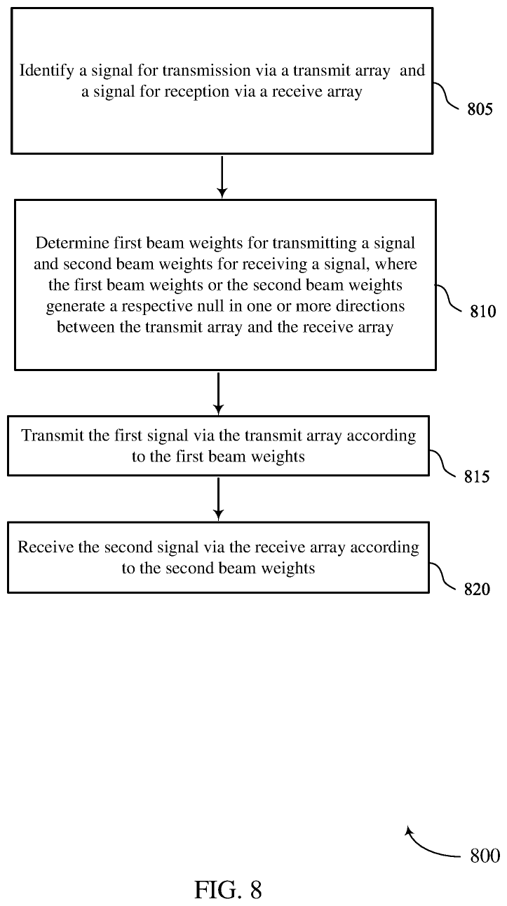

FIG. 8 illustrates a flowchart illustrating a method 800 that supports full-duplex beam-nulling isolation between transmit and receive arrays in accordance with aspects of the present disclosure. The operations of method 800 may be implemented by a phased array antenna system or its components as described herein. For example, the operations of method 800 may be performed by a beam weight manager as described with reference to FIGS. 6 and 7. In some examples, a phased array antenna system may execute a set of instructions to control the functional elements of the phased array antenna system to perform the functions described herein. Additionally, or alternatively, a phased array antenna system may perform aspects of the functions described herein using special-purpose hardware.

At 805, the method may include a phased array antenna system identifying a signal for transmission via a transmit array and a signal for reception via a receive array. The receive array and the transmit array may be located proximate to each other in the phased array antenna system. The operations of 805 may be performed in accordance with examples as disclosed herein. In some examples, aspects of the operations of 805 may be performed by a signal manager 620 as described with reference to FIG. 6.

At 810, the method may include a phased array antenna system determining beam weights for transmitting a signal from the transmit array in a target direction and determining beam weights for receiving a signal via the receive array in a target direction. The respective beam weights generate a respective null in one or more directions between the transmit array and the receive array. The operations of 810 may be performed in accordance with examples as disclosed herein. In some examples, aspects of the operations of 810 may be performed by a beam manager 625 as described with reference to FIG. 6.

At 815, the method may include transmitting the signal from the transmit array according to the beam weights for the transmit array. The operations of 815 may be performed in accordance with examples as disclosed herein. In some examples, aspects of the operations of 815 may be performed by a signal manager 620 as described with reference to FIG. 6.

At 820, the method may include receiving the signal via the receive array according to the beam weights for the receive array. The operations of 820 may be performed in accordance with examples as disclosed herein. In some examples, aspects of the operations of 820 may be performed by a signal manager 620 as described with reference to FIG. 6.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non transitory computer storage media and communication media including any medium that facilitates transfer of a computer program from one place to another. A non transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for mitigating self-interference at a transceiver of a phased array antenna system, comprising:
identifying a first signal for transmission via a transmit array of the phased array antenna system and a second signal for reception via a receive array of the phased array antenna system, wherein the receive array and the transmit array are located proximate to each other in the phased array antenna system
determining first beam weights for transmission of the first signal towards a first target direction via the transmit array and second beam weights for reception of the second signal from a second target direction via the receive array wherein one or more of the first beam weights or the second beam weights generate a respective null in one or more directions between the transmit array and the receive array, wherein determining the first beam weights comprises:
determining a first subset of the first beam weights for a first subset of transmit antenna elements of the transmit array and a second subset of the first beam weights for a second subset of transmit antenna elements of the transmit array, the first subset of transmit antenna elements comprising one or more antenna elements located closest to the receive array wherein the first subset of the first beam weights are determined to generate the respective null in the one or more directions between the transmit array and the receive array, and wherein the second subset of the first beam weights are determined to orient a primary lobe of a beam in the first target direction, and
combining the first subset of the first beam weights with the second subset of the first beam weights;
transmitting the first signal via the transmit array according to the first beam weights; and
receiving, at least partially concurrently with transmitting the first signal, the second signal via the receive array according to the second beam weights.

2. The method of claim 1, further comprising:
calculating a power level of a component of the first signal received at the receive array;
comparing the power level of the received component of the first signal to a power threshold; and
adjusting one or more of the first beam weights or the second beam weights based at least in part on determining that the power level of the received component of the first signal exceeds the power threshold.

3. The method of claim 1, wherein adjusting the one or more of the first beam weights or the second beam weights further comprises:
adjusting one or more phase components or amplitude components of the one or more of the first beam weights or the second beam weights.

4. The method of claim 1, wherein the one or more of the first beam weights or the second beam weights correspond to one or more antenna elements of the transmit array located closest to the receive array or one or more antenna elements of the receive array located closest to the transmit array.

5. The method of claim 1, wherein adjusting the one or more of the first beam weights or the second beam weights is based at least in part on a beam nulling function, a scan angle, an algorithmic search pattern, an artificial intelligence function, or a combination thereof.

6. The method of claim 1, further comprising:
calculating a signal to noise ratio of the first signal received at the receive array;
comparing the signal to noise ratio of the first signal to a threshold; and
adjusting one or more of the first beam weights or the second beam weights based at least in part on the comparison.

7. (canceled)

8. The method of claim 1, wherein the first subset of transmit antenna elements comprise one or more rows of transmit antenna elements located along an edge of the transmit array closest to the receive array.

9. A method for mitigating self-interference at a transceiver of a phased array antenna system, comprising:
identifying a first signal for transmission via a transmit array of the phased array antenna system and a second signal for reception via a receive array of the phased array antenna system, wherein the receive array and the transmit array are located proximate to each other in the phased array antenna system;
determining first beam weights for transmission of the first signal towards a first target direction via the transmit array and second beam weights for reception of the second signal from a second target direction via the receive array, wherein one or more of the first beam weights or the second beam weights generate a respective null in one or more directions between the transmit array and the receive array, wherein determining the second beam weights comprises:
determining a first subset of the second beam weights for a first subset of receive antenna elements of the receive array and a second subset of the second beam weights for a second subset of receive antenna elements of the receive array, the first subset of receive antenna elements comprising one or more antenna elements located closest to the transmit array, wherein the first subset of the second beam weights are determined to generate the respective null in the one or more directions between the transmit array and the receive array, and wherein the second subset of the second beam weights are determined to orient a primary lobe of a beam in the second target direction, and
combining the first subset of the second beam weights with the second subset of the second beam weights;
transmitting the first signal via the transmit array according to the first beam weights; and
receiving, at least partially concurrently with transmitting the first signal, the second signal via the receive array according to the second beam weights.

10. The method of claim 9, wherein the first subset of receive antenna elements comprise one or more rows of receive antenna elements located along an edge of the receive array closest to the transmit array.

11. The method of claim 1, wherein one or more of the first beam weights or the second beam weights is based at least in part on a type of the receive array, a type of the transmit array, a distance between the receive array and the transmit array, or a combination thereof.

12. The method of claim 1, wherein the receive array and the transmit array are coplanar.

13. The method of claim 1, wherein the first target direction and the second target direction are oriented towards a same target.

14. A phased array antenna system comprising:
a transmit array;
a receive array, wherein the receive array and the transmit array are located proximate to each other in the phased array antenna system;
a signal manager configured to identify a first signal for transmission via the transmit array and a second signal for reception via the receive array;
a beam manager configured to determine first beam weights for transmission of the first signal towards a first target direction via the transmit array and second beam weights for reception of the second signal from a second target direction via the receive array wherein one or more of the first beam weights or the second beam weights generate a respective null in one or more directions between the transmit array and the receive array, wherein, to determine the first beam weights, the beam manager is configured to:
determine a first subset of the first beam weights for a first subset of transmit antenna elements of the transmit array and a second subset of the first beam weights for a second subset of transmit antenna elements of the transmit array, the first subset of transmit antenna elements comprising one or more antenna elements located closest to the receive array, wherein the first subset of the first beam weights are determined to generate the respective null in the one or more directions between the transmit array and the receive array, and wherein the second subset of the first beam weights are determined to orient a primary lobe of a beam in the first target direction, and
combine the first subset of the first beam weights with the second subset of the first beam weights;
a transmitter configured to transmit the first signal via the transmit array according to the first beam weights; and
a receiver configured to receive, at least partially concurrently with transmitting the first signal, the second signal via the receive array according to the second beam weights.

15. The phased array antenna system of claim 14, further comprising:
a power level component configured to:
calculate a power level of a component of the first signal received at the receive array; and
compare the power level of the received component of the first signal to a power threshold, wherein:
the beam manager is configured to adjust one or more of the first beam weights or the second beam weights based at least in part on the power level component determining that the power level of the received component of the first signal exceeds the power threshold.

16. The phased array antenna system of claim 14, wherein:
the beam manager is configured to adjust one or more phase components or amplitude components of the one or more of the first beam weights or the second beam weights.

17. The phased array antenna system of claim 14, wherein the one or more of the first beam weights or the second beam weights correspond to one or more antenna elements of the transmit array located closest to the receive array or one or more antenna elements of the receive array located closest to the transmit array.

18. The phased array antenna system of claim 14, wherein the beam manager is configured to adjust the one or more of the first beam weights or the second beam weights is based at least in part on a beam nulling function, a scan angle, an algorithmic search pattern, an artificial intelligence function, or a combination thereof.

19. The phased array antenna system of claim 14, further comprising:
a power level component configured to:
calculate a signal to noise ratio of the first signal received at the receive array; and
compare the signal to noise ratio of the first signal to a threshold, wherein:
the beam manager is configured to adjust one or more of the first beam weights or the second beam weights based at least in part on the comparison.

20. (canceled)

21. The phased array antenna system of claim 14, wherein the first subset of transmit antenna elements comprise one or more rows of transmit antenna elements located along an edge of the transmit array closest to the receive array.

22. A phased array antenna system comprising:
a transmit array;
a receive array, wherein the receive array and the transmit array are located proximate to each other in the phased array antenna system;
a signal manager configured to identify a first signal for transmission via the transmit array and a second signal for reception via the receive array;
a beam manager configured to determine first beam weights for transmission of the first signal towards a first target direction via the transmit array and second beam weights for reception of the second signal from a second target direction via the receive array wherein one or more of the first beam weights or the second beam weights generate a respective null in one or more directions between the transmit array and the receive array, wherein, to determine the second beam weights, the beam manager is configured to:
determine a first subset of the second beam weights for a first subset of receive antenna elements of the receive array and a second subset of the second beam weights for a second subset of receive antenna elements of the receive array, the first subset of receive antenna elements comprising one or more antenna elements located closest to the transmit array, wherein the first subset of the second beam weights are determined to generate the respective null in the one or more directions between the transmit array and the receive array, and wherein the second subset of the second beam weights are determined to orient a primary lobe of a beam in the second target direction, and
combine the first subset of the second beam weights with the second subset of the second beam weights;
a transmitter configured to transmit the first signal via the transmit array according to the first beam weights; and
a receiver configured to receive, at least partially concurrently with transmitting the first signal, the second signal via the receive array according to the second beam weights.

23. The phased array antenna system of claim 22, wherein the first subset of receive antenna elements comprise one or more rows of receive antenna elements located along an edge of the receive array closest to the transmit array.

24. The phased array antenna system of claim 14, wherein one or more of the first beam weights or the second beam weights is based at least in part on a type of the receive array, a type of the transmit array, a distance between the receive array and the transmit array, or a combination thereof.

25. The phased array antenna system of claim 14, wherein the receive array and the transmit array are coplanar.

26. The phased array antenna system of claim 14, wherein the first target direction and the second target direction are oriented towards a same target.
